(19) United States
(12) Patent Application Publication
(10) Pub. No.: US 2003/0185644 A1
(43) Pub. Date: Oct. 2, 2003

(54) Fastener for plastic structure

(75) Inventor: Tae Hun Ju, Incheon-City (KR)

Correspondence Address: VOLPE AND KOENIG, P.C., UNITED PLAZA, SUITE 1600, 30 SOUTH 17TH STREET, PHILADELPHIA, PA, 19103, US

(73) Assignee: Dongyan Mechatronics Co., Ltd., Incheon-City (KR)

(21) Appl. No.: 10/405,135

(22) Filed: Apr. 2, 2003

(30) Foreign Application Priority Data
Apr. 2, 2002 (KR) 2002-18021

(51) Int. Cl. F16B 39/10

(52) U.S. Cl. 411/119

(57) ABSTRACT

A fastener for a plastic structure includes an elastic hook protrusion formed one of a fixing structure and a coupling structure integrally coupled to the fixing structure and having an extension portion maintaining a width of a profile extended than that of a body portion and a cut portion formed at a center of the extension portion in a lengthwise direction of the body portion, a one-way insertion portion formed on the other structure of the fixing structure and the coupling structure on which the elastic hook protrusion is not formed, having an inclined portion inclined in an elastic pipe form in a direction in which the elastic hook protrusion is inserted and a through hole formed in the coupling structure so that the elastic hook protrusion is inserted and hooked therein, and a wedge inserted in the cut groove of the elastic hook protrusion after the elastic hook protrusion is inserted in the one-way insertion portion to prevent the elastic hook protrusion from being separated from the one-way insertion portion.

### BACKGROUND OF THE INVENTION

This application claims the priority of Korean Patent Application No. 2002-18021 filed on Apr. 2, 2002 in the Korean Intellectual Property Office, the disclosure of which is incorporated herein in its entirety by reference.

1. Field of the Invention

The present invention relates to a fastener for a plastic structure, and more particularly, to a fastener for a plastic structure which can guarantee a firm and stable coupling state by inserting a wedge in a cut groove of a elastic hook protrusion after the elastic hook protrusion is coupled to the plastic structure.

2. Description of the Related Art

In general, as a means for fixing a structure to another structure, there is a screw fixing method by making a threaded hole in the structure and a protrusion insertion and fixing method in which a protrusion having a hook step is formed on one structure and a hole is formed in the other structure so that two structure are coupled.

Of the above two methods, the protrusion insertion and fixing method is advantageous in consideration of an efficiency in work and an economic value.

FIGS. 1 through 3 show examples of the protrusion insertion and fixing method which has been widely used up to date.

First, FIGS. 1 and 2 show an example of the protrusion insertion and fixing method including an elastic hook protrusion 10 having a hook step 13, which is applied to a case in which a fixing structure 1 and a coupling structure 2 are both made of plastic exhibiting elasticity.

The conventional fastener F includes the elastic hook protrusion 10 formed on the fixing structure 1 and a through hole 3 formed in the coupling structure 2 so that the elastic hook protrusion 10 can be inserted and hooked therein.

The elastic hook protrusion 10 includes a cylindrical protrusion body 11, an extension portion 12 formed at an end portion of the protrusion body 11 and having a width of a profile extended than the protrusion body 11, and a cut groove 14 formed to a predetermined depth along a lengthwise direction of the protrusion body 11 at the center of the extension portion 12. Due to the above structure, a hook step 13 is formed on a lower portion of the extension portion 12 so that the elastic hook protrusion 10 is inserted in the through hole 3 of the coupling structure 2 and hooked thereby.

That is, the cut groove 14 is formed in the extension portion 12 of the elastic hook protrusion 10 as an allowable gap in which the extension portion 12 is inserted by being compressed through the through hole 3. Here, since the elastic hook protrusion 10 is made of plastic exhibiting elasticity, the elastic hook protrusion 10 is deformed by being compressed as it passes through the through hole 3. Then, the elastic hook protrusion 10 is hooked by the through hole 3 as it recovers from the compressed state.

However, in the case of FIG. 2 which is different in the structure of the through hole 22, a one-way insertion portion 20 having an inclined portion 21 inclined in an elastic pipe form in a direction in which the elastic hook protrusion 10 is inserted is further provided so that the extension portion 12 of the elastic hook protrusion 10 inserted in the through hole 3 of the coupling structure 2 is not easily separated therefrom.

That is, the one-way insertion portion 20 protrudes from one surface of the coupling structure 2. A through hole 22 inclined in a direction in an elastic pipe form in which the elastic hook protrusion 10 is inserted is formed so that the elastic hook protrusion 10 is hooked. A plurality of slits 23 are formed along an inclination direction of the inclined portion 21 so that the slits 23 are compressed after the extension portion 12 of the elastic hook protrusion 10 passes. The slits 23 are formed in the one-way insertion portion 20 as an allowable gap so that the extension portion 12 of the elastic hook protrusion 10 is smoothly inserted therein. Since the one-way insertion portion 20 is made of a plastic material exhibiting elasticity so as to be returned to the original state once the elastic hook protrusion 10 is inserted, the one-way insertion portion 20 can support the elastic hook protrusion 10 by hooking the hook step 13 of the elastic hook protrusion 10 after the elastic hook protrusion 10 is inserted.

The elastic hook protrusion 10 can be applied to both of the case of FIG. 1 in which the through hole 3 is simply formed in the coupling structure 2 and the case of FIG. 2 in which the one-way insertion portion 20 having the inclined portion 21 is formed at the through hole 22. In particular, in the case of FIG. 2, a possibility that the elastic hook protrusion 10 is separated from the coupling structure 2 is rather small compared to the case of FIG. 1 due to the directivity by the inclined portion 21.

In the meantime, FIG. 3 shows another example of a conventional insertion and fixing method in which a hook protrusion 40 is formed on the fixing structure 1 and a one-way insertion portion 7 is formed on a coupling structure 6. The fixing structure 1 is made of a plastic material exhibiting elasticity and the coupling structure 6 is of a steel push nut type made of common steel.

The present fastener has a structure in which the hook protrusion 40 without additional extension portion is inserted in the one-way insertion portion 7 which is metal and does not have elasticity, so that separation in the opposite direction is prevented and a more firm and stable coupling state is available compared to the structures shown in FIGS. 1 and 2.

However, the above-described conventional fasteners have problems that a fixing stability is low or an additional equipment is needed in manufacturing thereof. That is, the fasteners shown in FIGS. 1 and 2 has a problem that, since the cut groove 14 of the elastic hook protrusion 10 is open after the fastener is coupled, the elastic hook protrusion 10 is easily separated by a slight external impact and decoupled from the fixing structure 1. In the fastener shown in FIG. 3, although the fixing state is firm, a manufacturing cost increases due to use of the steel push nit and an additional pressing equipment is needed for the manufacture of the fastener.

### SUMMARY OF THE INVENTION

To solve the above and/or other problems, the present invention provides a fastener for a plastic structure which can guarantee a firm and stable coupling state after the elastic hook protrusion is coupled to the plastic structure and provide a simple structure and lower a manufacturing cost.

Also, the present invention provides a fastener for a plastic structure which can be applied to a protrusion insertion and fixing method when a circuit board or a single plate structure is to be fixed.

According to an aspect of the present invention, a fastener for a plastic structure includes an elastic hook protrusion formed one of a fixing structure and a coupling structure integrally coupled to the fixing structure and having an extension portion maintaining a width of a profile extended than that of a body portion and a cut portion formed at a center of the extension portion in a lengthwise direction of the body portion, a one-way insertion portion formed on the other structure of the fixing structure and the coupling structure on which the elastic hook protrusion is not formed, having an inclined portion inclined in an elastic pipe form in a direction in which the elastic hook protrusion is inserted and a through hole formed in the coupling structure so that the elastic hook protrusion is inserted and hooked therein, and a wedge inserted in the cut groove of the elastic hook protrusion after the elastic hook protrusion is inserted in the one-way insertion portion to prevent the elastic hook protrusion from being separated from the one-way insertion portion.

The elastic hook protrusion is formed on the fixing structure and the one-way insertion portion is formed on the coupling structure corresponding to the elastic hook protrusion.

The elastic hook protrusion and the one-way insertion portion are made of a plastic material exhibiting elasticity.

The wedge comprises a cover portion which is fixedly capped around the extension portion of the elastic hook protrusion as the wedge is inserted in the cut groove of the elastic hook protrusion.

In a fixing structure including the elastic hook protrusion, the one-way insertion portion, and the wedge which is applied as a structure to fix cables of a wiper motor for a vehicle, the elastic hook protrusion is formed on the fixing structure by setting a portion of the wiper motor having a terminal portion to which cables supplying electricity are connected as the fixing structure, the one-way insertion portion is formed on the coupling structure by integrally extending the coupling structure with the cover such that the one-way insertion portion is coupled to the elastic hook protrusion by being capped around the fixing structure together with the conventional cover protecting the terminal portion, and the edge is fixedly inserted in the cut groove of the elastic hook protrusion. The fixing structure including the elastic hook protrusion, the one-way insertion portion, and the wedge is applied as a structure to fix a plurality of circuit boards by depositing the circuit boards one another.

### BRIEF DESCRIPTION OF THE DRAWINGS

The above and other features and advantages of the present invention will become more apparent by describing in detail preferred embodiments thereof with reference to the attached drawings in which:

FIG. 1 is a side view illustrating a conventional fixing structure applied to a general plastic structure;

FIG. 2 is an exploded perspective view illustrating the fixing structure of FIG. 1;

FIG. 3 is a side view illustrating another conventional fixing structure applied to a general plastic structure;

FIG. 4 is an exploded perspective view illustrating the structure of a fastener for a plastic structure according to a preferred embodiment of the present invention;

FIG. 5 is a view illustrating the outer and inner structures of the fastener of FIG. 4 coupled to the plastic structure;

FIG. 6 is an exploded perspective view illustrating the fastener for a plastic structure of FIG. 4 applied as a cable fixing structure to a wiper motor for a vehicle; and

FIG. 7 is a plan view illustrating a state in which the fastener of FIG. 6 is coupled.

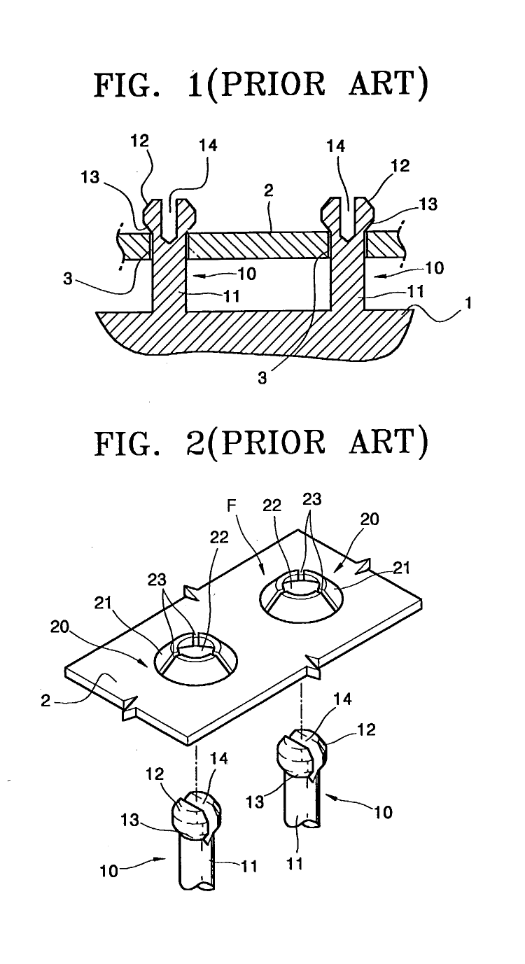

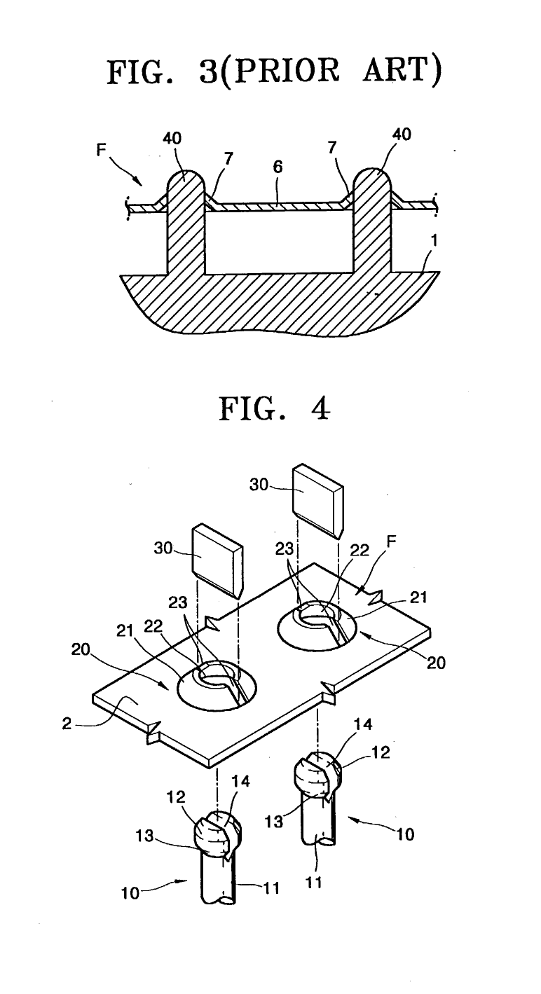

### DETAILED DESCRIPTION OF THE INVENTION

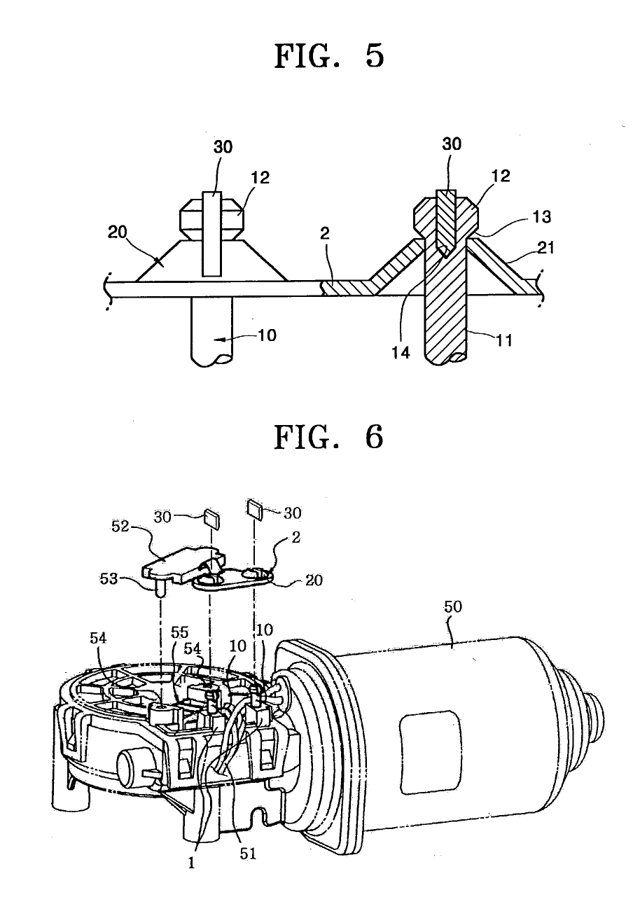

Referring to FIGS. 4 and 5, a fastener for a plastic structure according to a preferred embodiment of the present invention includes the elastic hook protrusion 10 formed one of the fixing structure 1 and the coupling structure 2 and having the extension portion 12 and the cut portion 14 formed thereon, the one-way insertion portion 20 formed on the other structure and having an inclined portion 21 protruding from one surface in an elastic pipe form, and a wedge 30 inserted in the cut groove 14 of the elastic hook protrusion 10 after the elastic hook protrusion 10 is inserted in the one-way insertion portion 20 to fix the coupling state.

That is, the elastic hook protrusion 10 is formed one of the fixing structure 1 and the coupling structure 2 integrally coupled to the fixing structure 1 and includes the cylindrical protrusion body 11, the extension portion 12 formed at an end portion of the protrusion body 11 and maintaining a width of the profile extending then that of the protrusion body 11, and the cut groove 14 formed to a predetermined depth along the lengthwise direction of the protrusion body 11 at the center of the extension portion 12. The hook step 13 hooked by the one-way insertion portion 20 of the coupling structure 2 after the elastic hook protrusion 10 is inserted is formed at a lower portion of the extension portion 12. In other words, the cut groove 14 is formed as an allowable gap to enable the extension portion 12 of the elastic hook protrusion 10 to be inserted in the through hole 22 by being compressed. Here, since the elastic hook protrusion 10 is made of a plastic material exhibiting elasticity, the elastic hook protrusion 10 is inserted in the through hole 22 by being compressed and returns to the original shape thereafter so as to be hooked by the through hole 22.

Also, the one-way insertion portion 20 is formed on one of the fixing structure 1 and the coupling structure 2 where the elastic hook protrusion 10 is not formed. The through hole 22 inclined in a direction in which the elastic hook protrusion 10 is inserted in an elastic pipe form so that the elastic hook protrusion 10 can be inserted and hooked thereby. A plurality of slits 23 are formed along a direction in which the inclined portion 21 is inclined so that the elastic hook protrusion 10 can be hooked thereby after the extension portion 12 of the elastic hook protrusion 10 is inserted in the through hole 22. That is, the slits 23 are formed as an allowable gap for a smooth insertion of the extension portion 12 of the elastic hook protrusion 10 inserted in the through hole 22 by being extended. Since the one-way insertion portion 20 is made of a plastic material exhibiting elasticity, the one-way insertion portion 20 is extended when the elastic hook protrusion 10 is inserted in the through hole 22 and returns to the original shape thereafter so as catch and support the hook step 13 of the elastic hook protrusion 10.

The wedge 30 is a coupling and fixing unit inserted in the cut groove 14 of the elastic hook protrusion 10 to prevent the elastic hook protrusion 10 from being separated from the one-way insertion portion 20 after the elastic hook protrusion 10 and the one-way insertion portion 20 are coupled.

In the present invention, as the wedge 30 is inserted in the cut groove 13 to prevent the extension portion 12 from being compressed, the outer circumference of the hook step 13 is firmly hooked by the circumference of the one-way insertion portion 20. The inner and outer coupling states are shown in FIG. 5.

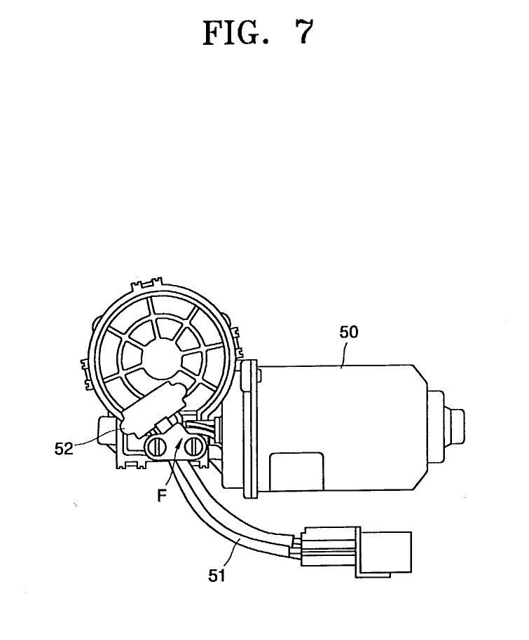

Although not shown in the drawing, the shape of the wedge 30 can be variously changed. For example, by forming the wedge 30 to have a double structure including a wedge portion and a cover portion, an inner wedge portion is inserted in the cut groove 14 of the elastic hook protrusion 10 and an outer cover portion is fixedly capped around the outer circumference of the extension portion 12 of the elastic hook protrusion 10. The fastener F having the above structure according to the present invention can be applied as a structure to fix a cable in a wiper motor for a vehicle, as shown in FIGS. 6 and 7. FIG. 6 is an exploded perspective view illustrating a fastener F for a plastic structure applied as a cable fixing structure to a wiper motor for a vehicle. FIG. 7 is a plan view illustrating a state in which the fastener of FIG. 6 is coupled.

As shown in the drawings, an appropriate position of a wiper motor 50 having a terminal portion 55 to which a plurality of cables 51 for supplying electricity are connected is set as the fixing structure 1 and the elastic hook protrusions 10 are formed at the fixing structure 1. A coupling protrusion 53 is formed on a lower surface of a cover 52 to protect the terminal portion 55 and simultaneously an insertion hole 54 in which the coupling protrusion 53 is inserted is formed at the terminal portion 55. Thus, as the cover 52 is coupled over the terminal portion 55, the terminal portion 55 can be protected. The coupling structure 2 on which a pair of one-way insertion portions 20 are formed corresponding to each of the elastic hook protrusions 10 is integrally formed at one side of the cover 52, so that the elastic hook protrusion 10 and the one-way insertion portion 20 are coupled to each other. The wedge 30 is inserted in the cut groove 14 of the extension portion 12 of the elastic hook protrusion 10 protruding through the through hole 22 of the one-way insertion portion 20.

When the fastener F of the present invention is applied to a circuit board or a single panel structure, a coupling state which is very firm can be maintained and, when an external impact is applied, the fastener is not detached. Also, the terminal portion to which cables are connected such as a circuit board can be protected and simultaneously as aesthetic appearance can be maintained.

As described above, in the fastener for a plastic structure according to the present invention, when the plastic structures are coupled to each other, since all the assembly is completed by fixedly inserting the wedge in the cut groove of the elastic hook protrusion after the elastic hook protrusion is coupled to the plastic structure, the coupling is made easy and a firm and stable coupling state is guaranteed by the operation of the wedge. Also, the present structure is very simple compared to other additional fixing method and can be easily applied to the conventional fixing structure. A manufacturing cost can be remarkably reduced.

Furthermore, the fastener of the present invention can be applied not only as a protrusion insertion and fixing method when a circuit board or a single panel structure is fixed, but also in a variety of fields.

While this invention has been particularly shown and described with reference to preferred embodiments thereof, it will be understood by those skilled in the art that various changes in form. and details may be made therein without departing from the spirit and scope of the invention as defined by the appended claims.

What is claimed is:

1. A fastener for a plastic structure comprising:
an elastic hook protrusion formed one of a fixing structure and a coupling structure integrally coupled to the fixing structure and having an extension portion maintaining a width of a profile extended than that of a body portion and a cut portion formed at a center of the extension portion in a lengthwise direction of the body portion;
a one-way insertion portion formed on the other structure of the fixing structure and the coupling structure on which the elastic hook protrusion is not formed, having an inclined portion inclined in an elastic pipe form in a direction in which the elastic hook protrusion is inserted and a through hole formed in the coupling structure so that the elastic hook protrusion is inserted and hooked therein; and
a wedge inserted in the cut groove of the elastic hook protrusion after the elastic hook protrusion is inserted in the one-way insertion portion to prevent the elastic hook protrusion from being separated from the one-way insertion portion.

2. The fastener as claimed in claim 1, wherein the elastic hook protrusion is formed on the fixing structure and the one-way insertion portion is formed on the coupling structure corresponding to the elastic hook protrusion.

3. The fastener as claimed in claim 1, wherein the elastic hook protrusion and the one-way insertion portion are made of a plastic material exhibiting elasticity.

4. The fastener as claimed in claim 1, wherein the wedge comprises a cover portion which is fixedly capped around the extension portion of the elastic hook protrusion as the wedge is inserted in the cut groove of the elastic hook protrusion.

5. The fastener as claimed in claim 1, wherein, in a fixing structure including the elastic hook protrusion, the one-way insertion portion, and the wedge which is applied as a structure to fix cables of a wiper motor for a vehicle, the elastic hook protrusion is formed on the fixing structure by setting a portion of the wiper motor having a terminal portion to which cables supplying electricity are connected as the fixing structure,
the one-way insertion portion is formed on the coupling structure by integrally extending the coupling structure with the cover such that the one-way insertion portion is coupled to the elastic hook protrusion by being capped around the fixing structure together with the conventional cover protecting the terminal portion, and
the edge is fixedly inserted in the cut groove of the elastic hook protrusion.

6. The fastener as claimed in claim 1, wherein the fixing structure including the elastic hook protrusion, the one-way insertion portion, and the wedge is applied as a structure to fix a plurality of circuit boards by depositing the circuit boards one another.
